(19) United States
(12) Patent Application Publication
(10) Pub. No.: US 2008/0008864 A1
(43) Pub. Date: Jan. 10, 2008

(54) Colored leather product and manufacturing method thereof

(76) Inventor: Yoshikatsu Itoh, Fukui-shi (JP)

Correspondence Address: JORDAN AND HAMBURG LLP, 122 EAST 42ND STREET, SUITE 4000, NEW YORK, NY, 10168, US

(21) Appl. No.: 11/824,889

(22) Filed: Jul. 2, 2007

(30) Foreign Application Priority Data
Jul. 4, 2006 (JP) 2006-184090

(51) Int. Cl. G03G 7/00; B44C 1/00

(52) U.S. Cl. 428/195.1; 427/466

(57) ABSTRACT

A colored leather product printed with images of high quality and also excellent in the wear resistance having an anionic base coat layer on a leather surface, a cationic ink receiving layer on the base coat layer, and a top coat layer on the ink receiving layer in which images are formed by applying a pigment to the ink receiving layer, the colored leather product being obtained by a manufacturing method including forming an anionic base coat layer to a leather surface, forming a cationic ink receiving layer to the surface formed with the base coat layer, forming images to the ink receiving layer using a pigment ink by an inkjet system and forming a top coat layer above the ink receiving layer formed with the images.

### BACKGROUND OF THE INVENTION

1. Field of the Invention

The present invention concerns a colored leather product in which images are printed on natural leather and a manufacturing method thereof.

2. Description of the Related Art

Natural leather is used in various applications as materials having feeling of a high quality. While most of products thereof are solid colored, those applied with design for providing an impression different from the solid colored products are also present. Examples of providing the design include those printed by screen printing or those applied with unevenness by embossing on the leather surface. However, it can be said that such conventional methods are suitable to mass production but not suitable to small-lot production such as for natural leather materials. Further, in recent years, it has felt limitation in the expression for printing by the screen printing along with sophisticated demand for the design.

Under the situations as described above, a method of utilizing an inkjet system has been studied as a new method of printing natural leather and several reports have been made so far. As an example, JP-A No. 09-59700 proposes a leather product having an aqueous undercoat material layer on a substrate comprising a leather material, having further thereon a porous ink receiving layer containing alumina hydrate in which images drawn by an inkjet system are fixed, and providing further thereon a light permeable protective layer.

Natural leather is generally formed into products by way of various steps, for example, untreated hide and skin (adult cattle), soaking, backing, unhairing and lime dipping, splitting, scudding, re-liming, de-liming and bating, pickling, tanning, squeezing, shaving, rechrome tanning, neutralization, dying and oiling, squeezing, drying, conditioning, staking, toggling and tacking, trimming, buffing and correcting, seasoning and coating, glazing and pressing and metering. In a case of printing the natural leather by utilizing the inkjet system, it is important to determine which stage in the process the inkjet printing is to be applied.

That is, as an ink used for conducting inkjet printing thereof, an aqueous ink is often selected as it is easy to handle, and a sufficient ink receiving capacity is necessary for the natural leather to receive the aqueous ink. If the ink receiving capacity is insufficient, the ink blurs and satisfactory images can not be formed.

In the manufacturing steps for leather products, since the ink receiving capacity can be expected to some extent before the coating step, inkjet printing is conducted usually before the coating step. However, since natural leather involves many defects due to scratches, vermiculate holes, etc. or variations of surface shapes due to inherent individual differences, it was difficult to attain a uniform ink receiving capacity at a high level.

In the invention of JP-A No. 09-059700, it has been attempted to obtain a uniform ink receiving capacity at a high level by the provision of a porous ink receiving layer containing alumina hydrate. However, it is considered for the leather products manufactured with such a constitution that a layer having voids is present therein and no sufficient wear resistance can be obtained. In addition, since the color of alumina hydrate is white, the white color quite different from the color on the leather surface is recognized visually at portions where the cross section is observed such as seams of the leather products which may possibly lead to the loss of high quality feeling.

### BRIEF SUMMARY OF THE INVENTION

The present invention has been accomplished in view of the foregoings and it intends to provide a colored leather product printed with images at high quality and also excellent in the wear resistance, as well as a manufacturing method therefore.

The invention provides the following means for solving the subject.

That is, the colored leather product of the invention has an anionic base coat layer on a leather surface, a cationic ink receiving layer on the base coat layer, and a top coat layer on the ink receiving layer, in which a pigment is applied to the ink receiving layer thereby forming images.

In the colored leather product, the ink receiving layer may contain a cationic substance and a water soluble resin.

The ink receiving layer may further contain a urethane resin.

The thickness of the ink receiving layer is preferably within a range from 2 to 10 μm.

Further, the base coat layer may contain an anionic resin.

Further, the top coat layer preferably has at least one anionic layer in contact with the ink receiving layer.

A second top coat layer containing a silicone resin may be present further on the anionic top coat layer.

Further, at least one of the leather and the base coat layer may have a color similar with that of a background color for images formed to the ink receiving layer.

According to the manufacturing method of the colored leather products of the invention, a colored leather product of the invention is obtained by forming an anionic base coat layer on a leather surface, forming a cationic ink receiving layer on the surface formed with the base coat layer, forming images to the ink receiving layer using a pigment ink by an ink jet system, and forming a top coat layer on the ink receiving layer formed with the images.

In the manufacturing method of the invention, at least one of the leather and the base coat layer may be previously colored with a color similar with that of the background color of images formed to the ink receiving layer.

According to the invention, a colored leather product printed with images at high quality and also excellent in the wear resistance, as well as a manufacturing method thereof can be provided.

### DETAILED DESCRIPTION OF THE INVENTION

Preferred embodiments of the invention are to be described specifically.

The leather used in the invention may be those before the coating step in known fabrication steps for natural leather described above and kinds of the leather, etc. are not particularly restricted.

In the invention, an anionic base coat layer is at first formed to the leather. The purpose of forming the base coat layer is to make the leather surface uniform thereby forming images at high quality. Further, the layer is made anionic for improving the adhesion relative to the ink receiving layer to be described later. For forming the anionic base coat layer, an anionic resin may be used for instance.

Examples of the anionic resin include emulsion of homopolymers synthesized from unsaturated alkyl anionic materials and containing carboxylates, sulfonates and phosphates and the like contained in the molecular structure thereof or copolymers synthesized from them and unsaturated alkyl materials. As the resin, urethane resins or acrylic resins can be used suitably.

For forming the anionic base coat layer, those formed by adding an anionic surfactant to a nonionic resin emulsion can also be used. Most of the anionic surfactants have structures such as of carboxylate, sulfonate, phosphate in the molecules thereof like the anionic resins described above, and various kinds of anionic surfactants such as aliphatic acid type, linear alkylbenzene type, higher alcohol type, α-olefinic acid type and normal paraffinic type can be used.

The thickness of the base coat layer is preferably from 30 to 50 μm in order to make the leather surface uniform and enhance the visual recogniability of the images. However, it is also possible to increase the thickness further thereby providing those of high strength and less exfoliation.

The base coat layer may optionally be colored by the addition of a colorant to a base coat resin solution. For example, in a case of coloring the base coat layer by a color similar with that of the background color for the printed images, this is preferred since the amount of the ink received in the ink receiving layer can be decreased upon ink jet printing to be described later.

“Background color” means herein a color having a maximum area in the images formed to the ink receiving layer. Further, “color similar with that of the background color” means a color contained within a range of ±45°, preferably, ±22.5° relative to a line which is drawn from a measured value for the background color to an original point (0, 0) in a*b* space coordination values excluding the L value in the La*b* color space. However, in a case where the number of colors to be used is large and they are dotted, and application of the concept of the background color is difficult, the color for the base coat may be white, or a color determined optionally may also be used.

Further, the leather is sometimes colored previously, and it is preferred to previous coloration by a color identical with that of the base coat layer since the cross-section of the natural leather becomes less conspicuous.

For the method of forming the base coat layer, known methods such as spraying, roll coating or hand coating can be used with no particular restriction.

Then, an ink receiving layer is formed to the surface where the base coat layer has been formed. The ink receiving layer preferably contains three ingredients of a cationic material, a water soluble resin and an urethane resin as the constituent ingredient of the ink receiving layer. Further, it may comprise two ingredients of a cationically modified urethane resin and the water soluble resin by the use of the cationically modified urethane resin.

That is, by adding the cationic material, the ink receiving layer can be made cationic, and the adhesion with the anionic base coat layer can be improved. Further, in a case of conducting inkjet printing to be described later, a pigment ink is used as a colorant. Since the pigment ink is generally anionic, the ink can be deposited on the surface of the receiving layer and solidified to form images of high quality in a case where the ink receiving layer is cationic.

For the cationic material, those of different molecular weights or chemical structures may be used each alone or in admixture. For example, they include cationic resins and cationic surfactants and, more specifically, include resins comprising copolymers of polyimines such polyalkylene imine, polyamines such as polyalkylamine, polyalkylene polyamine, polyallylamine, polyacrylamine, or polydiallyl amine, polyamides such as polyalkylene polyamides, polyallylamide or polyacrylamide and, further, dicyane diamide polyalkylene polyamine, dicyane diamide triethylene tetramine, etc. having plural kinds of such cationic functional groups thereof, or copolymers of compounds having such cationic functional groups, or copolymers comprising the compounds having the cationic functional groups and a nonionic alkylene oxide, vinyl alcohol, styrene, or epihalohydrine, or surfactants such as monoalkylamine salts, dialkylamine salts, trialkylamine salts, halogenated alkyltriethyl ammonium, halogenated dialkyldimethyl ammonium, and halogenated alkyl benzalconioum.

Further, the water soluble resin is added with an aim of retaining the water content in the ink after ink deposition and preventing ink blurring. It includes as specific examples, polyvinyl alcohol, polyvinyl pyrrolidone, polyvinyl methyl ether, sodium polyacrylate, polyacryl amide, polyethylene oxide, polyethylene imine, carboxyvinyl polymer, starch, guar gum, locust bean gum, tamarind gum, Abeimoechus manihot, gum Arabic, tragacanth gum, konnyaku, sodium alginate, Gloipeltis, carageenan, agar, gelatin, casein, chitin, xanthan gum, dextran, carboxymethyl cellulose, hydroxyethyl cellulose, carboxymethyl hydroxyethyl cellulose, methyl cellulose, methylhydroxy cellulose, hydroxypropyl cellulose, dextrin, British gum, carboxymethyl starch, hydroxyethyl starch, carboxyethyl starch, carboxymethyl guar gum, hydroxypropyl guar gum, and hydroxyethyl guar gum.

Further, the urethane resin is added with an aim of improving the film strength and the flexibility of the ink receiving layer or improving the adhesion with a top coat layer to be described later. Among them, not yellowing type aliphatic urethane resins are preferred with a view point of favorable light fastness and, depending on other physical properties required, any of etheric, esteric or polycarbonate type may be used alone or in admixture.

The color of the ink receiving layer is preferably colorless transparent so as not to hinder the color of the leather as a base (it is sometimes colored or not colored).

The thickness of the ink receiving layer is preferably within a range from 2 μm to 10 μm. In a case where it is less than 2 μm, the ink receiving capacity is insufficient. In a case where it exceeds 10 μm, it may possibly result in a problem of making the feeling of the leather rigid causing difficulty for keeping the flexibility or worsening the physical property such as wear resistance.

Also the method of forming the ink receiving layer is not particularly restricted and a known method such as spraying, roll coating or hand coating may be used.

In the invention, after providing the ink receiving layer to the leather as described above, inkjet printing is conducted using a pigment ink. The pigment is used as the colorant because it is excellent in the light fastness and weather proofness compared with dyes.

For the kind of the pigment, either organic or inorganic type can be used and examples of the organic pigment include nitroso pigments, died lakes, azolakes, insoluble azos, monoazos, disazos, condensed azos, benzoimidazolones, phthalocyanines, anthraquinones, perylenes, quinacridones, dioxazines, isoindolines, azomethines, and pyrrolopyroles, and examples of the inorganic dye include, for example, oxides, hydroxides, sulfides, ferrocyanates, chromates, carbonates, silicates, phosphates, carbons (carbon blacks) and metal powders.

In the pigment ink, the pigment is usually dispersed and stabilized by a dispersant. As the dispersant, either a surfactant type or a polymeric type can be used and it is preferably anionic with an aim of further enhancing the effect of deposition and solidification further upon ink deposition to the ink receiving layer.

It is naturally possible to add other additives such as heat stabilizer, antioxidant, antiseptic agent, pH controller, defoamer, penetrating agent, binder, etc. optionally to the ink.

Adhesion between pigment solid contents to each other can be improved by adding the binder in an amount identical with or more than that of the pigment in the ink but since formation of the film on the nozzle surface may possibly cause occurrence of nozzle clogging in this case, it is preferred that the amount of the binder is less than that of the pigment.

A pigment ink can be obtained by dispersing the pigment and the like using a dispersing device such as a roll mill, ball mill, colloid mill, jet mill, or beads mill and then applying filtration.

The apparatus used for conducting the inkjet printing is not particularly restricted and any of printing apparatus can be used.

The ink receiving capacity of the ink receiving layer is preferably from 20 to 200 g/m² and, more preferably, from 50 to 100 g/m². In a case where it is less than 20 g/m², the ink can not be received sufficiently making it difficult to form images at high quality. In a case where it exceeds 200 g/m², the ink absorbing capacity is excessively high making it necessary to increase the ink application amount in order to obtain an appropriate blur of ink dots. In a case where the application amount is small, streaks due to blank portions between dots may possibly occur.

The ink application amount is, preferably, 70% or less or, more preferably, 50% or less of the ink receiving capacity of the ink receiving layer. The ink receiving capacity in this specification means an application amount of the ink that causes blur when a solid matrix is printed at a 5 g/m² pitch by inkjet using an ink containing a water soluble dye dissolved therein.

In a case of considering the adhesion between the ink receiving layer and the top coat layer to be described later, it is desirable that the application amount of the solid content of the pigment is smaller. The reason is as described below.

That is, after deposition of the pigment ink to the ink receiving layer, most of the pigment in the pigment ink is separated from water and deposited due to the difference of the ionic property. In this case, the pigment ink partially penetrates into the ink receiving layer.

With lapse of time, the water content at the periphery of the solid content deposited on the ink receiving layer is dried and, finally, the solid content of the pigment ink is present on the ink receiving layer.

As a result, the pigment is present as particles on the ink receiving layer and, accordingly, when the pigment covers a most portion on the surface of the ink receiving layer, it not only eliminates the cationic property of the ink receiving layer but also no sufficient adhesion can be obtained because of the presence of the pigment solid content as the particles.

Then, the solid content of the pigment applied in the ink receiving layer is, preferably, 0.4 mg or less, more preferably, 0.2 mg or less and, further preferably, 0.1 mg or less based on a 1 cm² area.

Further, in the invention, after forming images by inkjet printing, a top coat layer is formed with an aim of protecting the formed images. The top coat layer is preferably anionic with a view point of adhesion to the ink receiving layer, and the anionic layer can be formed by using an anionic resin.

For the kind of the resin, urethane resins, acrylic resins, etc. can be used with no particular restriction and blending of the urethane resin is preferred also for the top coat layer like the base coat layer and the ink receiving layer in that the adhesion can be made more excellent. The urethane resin used in this case is not particularly restricted and a polycarbonate type polyurethane is preferred with a view point of favorable physical property.

Further, as the method of coating the top coat layer, it is preferred to form two or more kinds of top coat layers of different chemical compositions successively.

That is, the first top coat layer is preferably formed by using an anionic resin in view of adhesion to the ink receiving layer and it is further preferred to use those of composition with addition of a crosslinking agent for improving the adhesion or increasing the strength.

Then, by blending the silicone resin in the second top coat layer, a product of further excellent wear resistance can be obtained. The second top coat layer has good adhesion in a case where it has a composition similar to that of the first top coat layer and, specifically, it is preferred to use a resin composition used for forming the first top coat layer by addition of a silicone resin. A nonionic resin may also be used providing that it is structurally similar with the resin used for the first top coat layer.

In a case of disposing the first top coat layer as described above, further improvement for the adhesion can be expected, since the adhesion between the second top coat layer containing the silicone ingredient and the first top coat layer is preferred and the adhesion between the pigment layer and the ink receiving layer, and the first top coat layer is preferred. It is naturally possible to add, as other ingredients, additives such as gloss controller, light fastness improver, heat stabilizer, antioxidant, corrosion inhibitor, pH controller, defoamer, and penetrating agent.

The thickness of the top coat layer is preferably from 10 to 40 μm in view of the wear resistance and the flexibility. In a case of laminating the top coat layer by two or more layers, the thickness for the entire layers is preferably within the range described above.

The method of forming the top coat layer can be practiced by known methods such as spraying, roll coating and hand coating with no particular restriction.

As described above, according to the invention, adhesion between each of the layers is improved by making the ionic property different successively in the base coat layer, the ink receiving layer, the pigment ink and the top coat layer.

### EXAMPLE

The present invention is to be described by way of examples but the invention is not always restricted to such examples.

### Example 1

Natural leather treated through the following steps by a customary method was prepared: untreated hide and skin (adult cattle), soaking, backing, unhairing and lime dipping, splitting, scudding, re-liming, de-liming and bating, pickling, tanning, squeezing, shaving, rechrome tanning, neutralization, dying and oiling, squeezing, drying, conditioning, staking, toggling and tacking, trimming, and buffing and correcting. The natural leather is dyed white.

### <Application of Base Coat Layer>

A base coat solution of the following formulation was used.

| | |
|---|---|
| LCC FF color WHITE R-5 (nonion/anion) | 10 parts by weight |
| LCC Filler MK (filler: nonion/anion) | 10 parts by weight |
| LCC BINDER S-640K (acryl emulsion: nonion/ | 40 parts by weight |
| anion) | |
| LCC BINDER UB-1512 (urethane emulsion: anion) | 20 parts by weight |
| LCC ASSISTER RL (leveling agent: anion) | 2 parts by weight |
| LCC Thickner NA-3 (thickener) | 2 parts by weight |
| Purified water | 10 parts by weight |

(*: all chemicals were manufactured by Dainippon Ink and Chemicals Inc.)

By using an NK cup (manufactured by ANEST IWATA Corp.) at a room temperature of 25° C., viscosity was conditioned by using a thickener and purified water such that the flowing time of the base coat solution of the preparation described above was 40 sec. Then, the base coat solution was applied at a total wet coating amount of 150 g/m² to the prepared natural leather by using a reverse roll coater and dried at 80° C. for 5 min by using a drier. When the thickness of the base coat layer was measured after drying by using an electron microscope, it was 35 μm. Also in the followings, measurement for the thickness was conducted by using the electron microscope.

### <Application of Ink Receiving Layer>

An receiving layer solution of the following formulation was used.

| | |
|---|---|
| PATERACOL IJ-26 (modified urethane: cation: | 100 parts by weight |
| non-volatile component 15%: manufactured by | |
| Dainippon Ink Chemicals and Inc.) | |
| Gosenol KL-03 (polyvinyl alcohol: nonion: Nippon | 3 parts by weight |
| Synthetic Chemical Industry Co.) | |
| Purified water | 30 parts by weight |

By using an NK cup (manufactured by ANEST IWATA Corp.) at a room temperature of 25° C., viscosity was conditioned by using purified water such that the flowing time of the ink receiving layer solution of the preparation described above was 50 sec. Then, the ink receiving layer solution was applied at a total wet coating amount of 30 g/m² to the base coated surface by using a reverse roll coater and dried at 80° C. for 2 min by using a drier. Since the applied inkjet receiving layer was transparent, the natural leather after drying had a white color which is the coating color of the base coat layer and there was no change for the tone of the white color, etc. Further, the ink receiving capacity of the ink receiving layer was 80 g/m² and the thickness of the ink receiving layer was 7 μm. For the method of measuring the ink receiving capacity, a solid color matrix was inkjet printed at a 5 g/m² pitch with an ink containing a water soluble dye (Blue Direct dye: C.I. Direct Blue 86, trade name of products: Sumilight Supra Turquoise Blue G, manufactured by Sumika Chem-Taoka Chemical Co.) as an 1% aqueous solution of the dissolved dye and an application amount that caused ink blur was examined to determine the ink receiving capacity.

### <Conduction of Inkjet Printing>

### [Preparation of Pigment Ink]

Each of the ingredients according to the following formulation was mixed in a mixer, dispersed by a beads mill for 3 hours and filtered to prepare a pigment ink.

Yellow ink

| | |
|---|---|
| PV FAST YELLOW HG (benzimidazolone: manufactured by Clariant | 5 parts by weight |
| Co.) | |
| Polyty PS-1900 (Na salt of polystyrene sulfonic acid: | 2 parts by weight |
| anion: manufactured by Lion Co.) | |
| Dynamite glycerin (glycerin: manufactured by NOF Corp.) | 10 parts by weight |
| Purified water | 83 parts by weight |

Magenta

| | |
|---|---|
| PV FAST PINK E (quinacridone: manufactured by Clariant Co.) | 5 parts by weight |
| Polyty PS-1900 | 2 parts by weight |
| Dynamite glycerin | 10 parts by weight |
| Purified water | 83 parts by weight |

Cyan ink

| | |
|---|---|
| IRGALITE BLUE GLNF (copper phthalocyanine: manufactured by | 5 parts by weight |
| Ciba Speciality Chemicals Co.) | |
| Polyty PS-1900 | 2 parts by weight |
| Dynamite glycerin | 10 parts by weight |
| Purified water | 83 parts by weight |

Black ink

| | |
|---|---|
| MA7 (carbon black: manufactured by Mitsubishi Chemicals Co.) | 5 parts by weight |
| Polyty PS-1900 | 2 parts by weight |
| Dynamite glycerin | 10 parts by weight |
| Purified water | 83 parts by weight |

Printing was conducted using the thus prepared ink to the surface applied with the ink receiving layer under the following conditions by using an inkjet printer. After printing and leaving for 30 min at a room temperature printing, drying was conducted at 80° C. for 2 min by a drier.

### [Condition for Printing]

a) Nozzle diameter: 70 (μm)
b) Application voltage: 50 (V)
c) Pulse width: 20 (μs)
d) Driving frequency: 1 (kHz)
e) Resolution: 180 (dpi)
f) Evaluated print: ⁻ISO/JIS-SCD (identification code) N3 (name) fruits basket (in this case, the color for the base coat layer is preferably black in view of applying a color similar with that of the background color of images but a white color base coat layer was applied herein since the color of the colored layer by the ink jet printing is offset by the black color in a case of using the black color).
   : ISO/JIS-SCD (identification code) N5 (name) bicycle (in this case, the color for the base coat layer was preferably white in view of applying a color similar with that of the background color of images).

### <Application of Top Coat Layer>

A top coat solution of the following preparation was used.

| | |
|---|---|
| LCC WL CLEAR UX-2007 (urethane emulsion: | 60 parts by weight |
| anion) | |
| LCC WL CONDITIONER SL-5 (silicone: nonion/ | 5 parts by weight |
| anion) | |
| LCC Thickner NA-3 (thickener) | 2 parts by weight |
| Purified water | 20 parts by weight |

(*: all chemicals were manufactured by Dainippon Ink and Chemicals Inc.)

By using an NK cup (manufactured by ANEST IWATA Corp.) at a room temperature of 25° C., viscosity was conditioned by using a thickener and purified water such that the flowing time of the top coat solution of the preparation described above was 30 sec. Then, the top coat solution was applied to a total wet coating amount of 50 g/m² to the image forming surface by using spray and dried at 80° C. for 5 min by using a drier to obtain a colored leather product of the invention. The thickness of the top coat layer was 15 μm.

When the printed pattern for evaluation was evaluated with naked eyes, images of high quality with no defects such as blur or abrasion were formed. Further, when a test (JIS-K5600) was conducted by using a taper wear tester, with a wear wheel CS-1 at a condition of 500 g×2000 cycles, defects such as breakage for abrasion were not found and the wear resistance was also favorable. Further, since the applied ink receiving layer was colorless and transparent, the color of the colored leather products was white as the coating color of the base coat layer and there were no change for the tone of white color, etc.

### Example 2

A colored leather product of the invention was obtained in the same manner as in Example 1 except for changing the formulation of the ink receiving layer in Example 1 as described below.

As an ink receiving layer solution, the following formulation was used.

| | |
|---|---|
| HYDRAN WLI-602 (urethane: non-volatile | 50 parts by weight |
| component 40%: nonion; manufactured by | |
| Dainippon Ink and Chemicals Inc.) | |
| PVP K-30 (polyvinyl pyrrolidone: nonion: | 5 parts by weight |
| manufactured by ISP Japan Co.) | |
| HYMAX SC-507 (polyalkylene | 20 parts by weight |
| polyamine-dimethylamine-epichlorohydrin | |
| polycondensates: cation: manufactured | |
| by HYMO Co. Ltd.) | |
| Purified water | 20 parts by weight |

The application amount of the ink receiving layer solution was 30 g/m² as the total wet coating amount, the ink receiving capacity of the ink receiving layer was 70 g/m², and the thickness of the ink receiving layer was 8 μm.

When the printed pattern for evaluation was evaluated with naked eyes, images of high quality with no defects such as blur or abrasion were formed. Further, when a test (JIS-K5600) was conducted by using a taper wear testing machine, with a wear wheel CS-10, at a condition of 500 g×2000 cycles, defects such as breakage or abrasion were not found and the wear resistance was also favorable. Further, since the applied ink receiving layer was colorless and transparent, the color of the colored leather product was white as the coating color of the base coat layer and there were no change for the tone of the white color, etc.

### Example 3

A colored leather product of the invention was obtained in the same manner as in Example 1 except for changing the formulation of the top coat solution and the application method in Example 1 as described below.

As the top coat solution, the following formulation was used.

### <Top Coat First Solution>

| | |
|---|---|
| LCC WL CLEAR UX-2007 (urethane emulsion: | 60 parts by weight |
| anion) | |
| LCC WL FIXER UX-10 (isocyanate: solvent) | 5 parts by weight |
| LCC Thickner NA-3 (thickener) | 2 parts by weight |
| Purified water | 20 parts by weight |

(*: all chemicals were manufactured by Dainippon Ink and Chemicals Inc.)

### <Top Coat Second Solution>

| | |
|---|---|
| LCC WL CLEAR UX-2007 (urethane emulsion: | 60 parts by weight |
| anion) | |
| LCC WL CONDITIONER SL-5 (silicone: nonion/ | 5 parts by weight |
| anion) | |
| LCC Thickner NA-3 (thickener) | 2 parts by weight |
| Purified water | 20 parts by weight |

(*: all chemicals were manufactured by Dainippon Ink and Chemicals Inc.)

Viscosity was controlled with a thickener and purified water both for the top coat first solution and second solution by using an NK cup (manufactured by ANEST IWATA) at a room temperature of 25° C. such that the flowing time of the top coat solution of the formulation described above was 30 sec. Then, the top coat first solution was applied at a wet coating amount of 25 g/m² by using spray to the image formed surface, and dried at 80° C. for 5 min by a drier. Then, in the same manner, the top coat second solution was applied at a wet coating amount of 25 g/m², dried at 80° C. for 5 min by a drier to obtain a colored leather product. The thickness for the entire top coat layer after drying of both of the first solution and the second solution was 15 μm.

When the printed pattern for evaluation was evaluated with naked eyes, images of high quality with no defects such as blur or abrasion were formed. Further, when a test (JIS-K5600) was conducted by using a taper wear testing machine, with a wear wheel CS-10 at a condition of 500 g×2000 cycles, defects such as breakage or abrasion were not found and the wear resistance was also favorable. Further, since the applied ink receiving layer was colorless and transparent, the color of the colored leather product was white as the coating color of the base coat layer, and there were no changes for the tone of white color, etc.

### Comparative Example 1

A colored leather product of the invention was obtained in the same manner as in Example 1 except for changing the formulation of the ink receiving layer in Example 1 as described below.

As the ink receiving layer solution, the following preparation was used.

| | |
|---|---|
| HYDRAN WLI-602 (urethane: non-volatile | 50 parts by weight |
| component 40%: nonion; manufactured by | |
| Dainippon Ink and Chemicals Inc.) | |
| PVP K-30 (polyvinyl pyrrolidone: nonion: | 5 parts by weight |
| manufactured by ISP Japan Co.) | |
| Purified water | 10 parts by weight |

The application amount of the ink receiving layer solution was 50 g/m² as the total wet coating amount, the ink receiving capacity of the ink receiving layer was 15 g/m², and the thickness of the ink receiving layer was 10 μm.

When the printed pattern for evaluation was evaluated with naked eyes, blur was observed. Further, when a test (JIS-K5600) was conducted by using a taper wear testing machine, with a wear wheel CS-10 at a condition of 500 g×2000 cycles, breakage was caused after about 500 cycles. Further, since the applied ink receiving layer was colorless and transparent, the colored leather product was white as the coating color for the base coat layer with no change for the tone of white color, etc.

1. A colored leather product having an anionic base coat layer on a leather surface, a cationic ink receiving layer on the base coat layer, and a top coat layer on the ink receiving layer, images being formed by applying pigments to the ink receiving layer.

2. A colored leather product according to claim 1, wherein the ink receiving layer contains a cationic material and a water soluble resin.

3. A colored leather product according to claim 2, wherein the ink receiving layer further contains a urethane resin.

4. A colored leather product according to any one of claims 1 to 3, wherein the thickness of the ink receiving layer is within a range from 2 to 10 mm.

5. A colored leather product according to any one of claims 1 to 3, wherein the base coat layer contains an anionic resin.

6. A colored leather product according to any one of claims 1 to 3, wherein the top coat layer has at least one anionic layer in contact with the ink receiving layer.

7. A colored leather product according to claim 6, wherein a second top coat layer containing a silicone resin is further provided on the anionic top coat layer.

8. A colored leather product according to any one of claims 1 to 3, wherein at least one of the leather and the base coat layer has a color similar with that of the background color of images formed to the ink receiving layer.

9. A method of manufacturing a colored leather product, including forming an anionic base coat layer on a leather surface, forming a cationic ink receiving layer to the surface formed with the base coat layer, forming images to the ink receiving layer using pigment inks by an ink jet system and forming a top coat layer on the ink receiving layer formed with the images, thereby obtaining the colored product according to any one of claims 1 to 3.

10. A method of manufacturing colored leather product according to claim 9, wherein at least one of the leather and the base coat layer is previously colored with a color of similar with that of the background color of the images formed to the ink receiving layer.
